(19) United States
(12) Patent Application Publication
(10) Pub. No.: US 2018/0293986 A1
(43) Pub. Date: Oct. 11, 2018

(54) Worn device for conversational-speed multimedial translation between two individuals and verbal representation for its wearer

(71) Applicants: Sharat Chandra Musham, Austin, TX (US); Pranitha Paladi, Austin, TX (US)

(72) Inventors: Sharat Chandra Musham, Austin, TX (US); Pranitha Paladi, Austin, TX (US)

(21) Appl. No.: 15/485,166

(22) Filed: Apr. 11, 2017

(51) Int. Cl. G10L 15/26; G09B 21/00; G10L 13/04; G10L 15/24; G06F 17/28

(52) U.S. Cl. CPC G10L 15/265; G09B 21/009; G06F 17/289; G10L 15/24; G10L 13/043

(57) ABSTRACT

A novel system and multi-device invention that provide a means to communicate in real-time (conversationally) between two or more individuals, regardless of each individual's preferred or limited mode of transmission or receipt (by gesture, by voice—in Mandarin to German to Farsi, by text in any major language, and via machine learning, eventually by dialect).

Systems and methods for conversational communication between two individuals using multiple language modes (e.g. visual language and verbal language) through the use of a worn device (for hands-free language input capability) are provided. Information may be stored in memory regarding user preferences, as well as various language databases—visual to verbal to textural—or the system can determine and adapt to user (primary and second) preferences and modes based on direct input, and adapt. Core processing for worn device can be performed 1) off-device via cloud processing through wireless transmission, 2) on-board, or a 3) mix of both, depending on the embodiment, and location of use, for example if the user is out of range from access to a high-speed wireless network and needs to rely more on on-board processing, or to maintain conversational speed dual/real-time translation and conversion.

### CROSS-REFERENCE TO RELATED APPLICATIONS

Patent Application: 62447524, filed 18 Jan. 2017.

### BACKGROUND

This present invention relates to wearable (computing) devices, particularly for use in communication and multi-language modes (visual, verbal, textural language),

### Prior Art

Millions of people suffer from impaired speaking and hearing abilities; a many communicate by sign (visual/gestural) language, such as through American Sign Language (ASL), where letters may be formed by various hand gestures. This means of communication has proven sufficient for conversational-level richness of information transfer between individuals using sign language to communicate with one another, though many of these impaired hearers—and speakers—who can communicate fluently through sign language with fellow signers cannot communicate conversationally with even their own family members, in addition to being prevented in conversing with the billions of non-signing individuals in the world. Harlan Lane, Robert Hoffmeister, and Ben Bahan say in A journey into the deaf-world (San Diego, Calif.: Dawn Sign Press, 1996, p. 42), ASL is the language of a sizeable minority. Estimates range from 500,000 to two million speakers in the U.S. alone; there are also many speakers in Canada, and an estimated 15 million people “speak” ASL around the world, often as a second “deaf language” as a lingua franca in the broader international deaf community, to supplement their core “deaf language” (which can range, based on location, from Nigerian Sign Language (NSL) to British Sign Language (BSL). Compared to data from the Census Bureau, which counts other language minorities, ASL is the leading minority language in the U.S. after the “big four”: Spanish, Italian, German, and French.

To date, the most effective means of live/real-time conversational translation for hearing impaired with non-hearing impaired individuals or groups is via a (human) interpreter. That interpreter must be fluent in one of the 200 core sign languages currently used around the world, as well as one core language (or dialect) of the target group in communication. RID has a growing national membership of more than 16,000 and growing professional interpreters, transliterators, interpreting students and educators. But there are approximately 6500 different spoken and written languages used, and according to the World Health Organization (as of 2017, http://www.who.int), “over 5% of the world's population—360 million people—has disabling hearing loss; 328 million adults and 32 million children”, so the language barrier for signers is compounded by this second level variability. Such activities involve considerable effort on the part of the interpreter, since sign languages are distinct natural languages with their own syntax, different from any spoken language. The interpretation flow is normally between a sign language and a spoken language that are customarily used in the same country, such as French Sign Language (LSF) and spoken French in France, Spanish Sign Language (LSE) to spoken Spanish in Spain, British Sign Language (BSL) and spoken English in the U.K., and American Sign Language (ASL) and spoken English in the USA and most of Anglophone Canada (since BSL and ASL are distinct sign languages both used in English-speaking countries), etc. Sign language interpreters who can translate between signed and spoken languages that are not normally paired (such as between LSE and English), are also available, albeit less frequently. Natural language processing is a field of computer science, artificial intelligence, and computational linguistics concerned Real-time interpreting (of spoken or sign language). In video remote interpreting (VRI), the two clients (a sign language user and a hearing person who wish to communicate with each other) are in one location, and the interpreter is in another. The interpreter communicates with the sign language user via a video telecommunications link and with the hearing person by an audio link. VRI can be used for situations in which no on-site interpreters are available. Essentially, this is simple video messaging (e.g. Skype) without the use of sound. It is limited, of course, to two individuals who both know the same specific sign-language.

A 2015 article titled: “Demand for Sign Language interpreters Expected to Rise Nearly 50%” (Angie Sharp, wqad.com, Oct. 24, 2015), and the current lack of professional (fluent) English and American Sign Language interpreters with at best an 80% supply rate. The article explains: “[there are not enough interpreters to fill [needs] and with all the baby boomers retiring, we're going to be struggling very hard to keep up with the demand. There are several other reasons why the demand is high, including more people who are deaf or hard of hearing are in public situations more often, including children who are going to public schools more frequently. That means more interpreters are needed in schools”.

Sign Language is a completely different mode of language from (American) English, though it was developed in the early 19th century, American Sign Language (ASL) is the predominant sign language of Deaf communities in the United States and most of Anglophone Canada, Besides North America, dialects of ASL and ASL-based creoles are used in many countries around the world, including much of West Africa and parts of Southeast Asia. ASL is also widely learned as a second language, serving as a lingua franca. ASL is most closely related to French Sign Language (LSF). Since then, ASL use has propagated widely via schools for the deaf and Deaf community organizations. Despite its wide use, no accurate count of ASL users has been taken, though reliable estimates for American ASL users range to 500,000 persons, including a number of children of deaf adults. ASL users face stigma due to beliefs in the superiority of oral language to sign language, compounded by the fact that ASL is often glossed in English due to the lack of a standard writing system. Even so, ASL is one of only 137 sign languages used around the world (source: 2013 edition of Ethnoloque lists 137 sign languages in use around the world), though they all share a number of phonemic components, including movement of the face and torso as well as the hands. ASL is not a form of pantomime, but iconicity does play a larger role in ASL than in spoken languages. English loan words are often borrowed through fingerspelling, although ASL grammar is unrelated to that of English. ASL has verbal agreement and aspectual marking and has a productive system of forming agglutinative classifiers. Many linguists believe ASL to be a subject-verb-object (SVO) language, but there are several alternative proposals to account for ASL word order. In linguistic terms, sign languages are as rich and complex as any spoken language, despite the common misconception that they are not “real languages”. Professional linguists have studied many sign languages and found that they exhibit the fundamental properties that exist in all languages. While iconicity is more systematic and widespread in sign languages than in spoken ones, the difference is not categorical. The visual modality allows the human preference for close connections between form and meaning, present but suppressed in spoken languages, to be more fully expressed. This does not mean that sign languages are a visual rendition of a spoken language. They have complex grammars of their own, and can be used to discuss any topic, from the simple and concrete to the lofty and abstract. Sign languages, like spoken languages, organize elementary, meaningless units called phonemes into meaningful semantic units. So the language barrier for sign language and spoken language humans is not simply between ASL and English, but between over 100 complex sign languages and several thousand spoken languages. Simply training more humans to interpret between two languages is not a feasible solution to eliminate this barrier.

Recent advances in technology allow for basic gestural capture and interpretation for one-way conversion of sign language into written text, while this is a positive advance in only allowing for a person using sign language to communicate basic concepts to a non-speaker via a computer interface, it requires a large stationary computer and monitor and video capture rig, and only allows for one way translation, not 2 way communication at conversational level. These nascent computer programs with computer vision interpret blocks of sign language. One way, large, operator can translate what is being said, often without being able to see, or if when seeing, still referring to separate computer and not individual, While this is a step in the right direction, it still is a far cry from enabling conversation between voice-speaking and sign-speaking individuals and groups.

Some of these advances are referenced in prior art. U.S. Pat. No. 7,949,157 to Afzulpurkar, et al. (2011) claims “A method for a computer system to recognize a hand gesture comprising: obtaining a captured image at an image capture device, wherein the captured image includes an image object, the image object being an image of a hand, and producing a visual or audio output based on the hand gesture attributed to the image of the hand.”, it is assumed this device is meant for handheld use/acquisition (e.g. via smartphone), as it cites only one “hand”, the obvious limitation is a signer communicates via two hands, and thus this would be analogous to capturing the verbal language for translation of an individual with half a tongue, or more realistically, speaking only in verbs and not nouns, or subjects and not predicates.

Even translation programs for verbal and text language, are primarily delivered via computer based on on-board and cloud processing (via high speed, e.g. LAN, connection) needs, the few mobile applications are limited in capacity and length of translation. Even without the technology for translating sign-language via mobile application, using smart-phone technology would always present a problem, as a sign-language user must use both hands to communicate and cannot hold a smart-phone in one hand while recording their signing, let alone manipulating a program's interface to translate, send, or perform other related functions.

While U.S. Pat. No. 9,256,777 to Chang certainly improves on above cited prior art regarding visual language capture and digitization, citing “an electronic device to recognize a gesture of at least a hand, the gesture recognition method comprising: capturing a hand image of the hand, wherein the hand image includes a hand region; calculating a geometric center of the hand region; deploying at least a concentric circle on the hand image with the geometric center as a center of the concentric circles”, this patent focuses only on gesture recognition, which is in a broad sense already performed by pre-existing technology in the public domain. It also does not address the needs of a (bi-directional) conversation or translating multiple modes of language between two individuals in a conversation. In fact, Jia, in U.S. Pat. No. 8,837,780 (2014) specifically refers to this broader capture technology using an industry term in their background disclosure, “A gesture based Human Interface Device (HID) is a computer device that accepts input from humans and produces a corresponding command to the computer.”, so while Jia tries to embed the claim of that pre-existing technological set in their own claims, it has existed long enough to have its own industry nomenclature. JIA goes on to claim “A method for implementing a human based interface comprising: segmenting, by a computing device, data generated by an IR camera of an active area”, once again restating what an “HID” is and adding the limitation of capture through IR, which is an inferior technology for near-Ofield object “capture”, and lacking in detail at close range for use beyond general heat tracking, bio-related tracking. In fact, LeapMotion, in methods and systems for capturing motion and/or determining the shapes and positions of one or more objects in 3D space utilize cross-sections thereof” has proven, in their in-market implementation of their core technology which sprung from much of what was claimed in U.S. Pat. No. 8,638,989 B2 (2014), entitled: Systems and methods for capturing motion in three dimensional space” have proven that their means of implementation for 3D capture supersedes any other follow-on variations. Even with that said, for the purposes of capturing visual language data, not “special” capture technology, aside from general pre-existing technology and open source capture processing is necessary to retrieve the core data necessary to define and interpret meaning data from visual communication.

However, none of this prior art claims to enable two way “physical conversation” between two individuals whose language modes are structurally dissimilar (e.g. verbal versus visual encoded language meanings). However, while their means of capturing visual data are advanced, they are also unnecessary for a larger solution to this type of language barrier. Jia, in fact, as a core element of an independent claim specifies “identifying a peninsula object” as part of the core means; yet a peninsula object is merely an object separate from a background, or independent from other objects, something general cameras have been able to do from early times based on the basic properties of the physics of light. This is not novel; it's a restatement of reality, not man-made invention.

Additionally, prior art has focused on exterior field image capture, not point of view capture. In the case of gesture capture, this means a sign-language user, if the center of “human” in a human interface device (HID), means specifically, someone will use a device to record another's gestures via a camera, then translate from the visual format to other language mode to “interpret” what was captured. This, of course, takes the sign-language “speaker” out of a conversation, it becomes rather a segmented and unidirectional display of data, and not input for a second being's response output-input.

The solution would have to be a device that is physically positioned from a sign-language user's point of view, towards the target recipient of communication. This type of device would naturally fall under the category of “wearable computing”, though we will prove out invention is not “wearable, but worn”, by necessity of its core function.

Wearable computing is focused on wearable sensors with processing, for both human activity recognition and in simulating the language reality of another to coexist in a single conversational plane, albeit in augmented, or shared reality. Ronald Azuma, of Intel Labs, has defined an augmented reality application as “one that combines the real world with the virtual world, is interactive and in real-time, and is registered in three dimensions”. Often, the platform to deliver augmented reality is a wearable device; or in the case of a smart phone, a hand-held computer. Additionally, most people think of a wearable computer as a computing device that is small and light enough to be worn on one's body without causing discomfort. And unlike a laptop or a palmtop, a wearable computer is constantly turned on and is often used to interact with the real-world through sensors that are becoming more ubiquitous each day. Furthermore, information provided by a wearable computer can be very context and location sensitive, especially when combined with GPS, and also can perform their functions without the use of user/human hands for input. In this regard, the computational model of wearable computers differs from that of laptop computers and even smartphones. In the early days of research in developing augmented reality, many of the same researchers were also involved in creating immersive virtual environments. Early on, Paul Milgram from the University of Toronto, codified the thinking by proposing a virtuality continuum which represents a continuous scale ranging between the completely virtual world, a virtuality, and a completely real, reality (Milgram et al., 1994). The reality-virtuality continuum therefore encompasses all possible variations and compositions of real and virtual objects. The area between the two extremes, where both the real and the virtual are mixed, is the so-called mixed-reality—which Paul indicated consisted of both augmented-reality, where the virtual augments the real, and augmented virtuality, where the real augments the virtual. Another prominent early researcher in wearables, and a proponent of the idea of mediating reality, was Steve Mann (2001, 2002). Mann describes wearable computing as miniature body-borne computational and sensory devices; he expanded the discussion of wearable computing to include the more expansive term “bearable computing” by which he meant wearable computing technology that is on or in the body. The term “bearable”, or “worn” is more accurate for our device, to illustrate the difference, we submit U.S. Pat. No. 8,290,210 to Fahn, et al (2012), entitled “Method and system for gesture recognition”. The patent's first claim cites “A method of gesture recognition, configured to recognize a gesture performed by a user in front of an electronic product, the method comprising: capturing an image containing an upper body of the user; obtaining a hand area in the image; scanning the entire hand area by placing a first concentric center position of a first couple of concentric.” This art theoretically functions in capturing gestures, but once again, as the initiating sign-language (human) communicator as an object, and the device outside of them capturing. Very specifically, unidirectional transfer of information and interpretation, but not enabling active two-way conversation between two individuals using different modes of communication.

In U.S. Pat. No. 9,098,493 to Tardiff (2015), another “computer implemented method” for capturing visual language for translation is detailed, its primary claim cites: “A computer implemented method for interpreting sign language, comprising: capturing a scene using a capture device, the scene including a human target; tracking movements of the human target in the scene; detecting one or more gestures of the human target in the scene; comparing the one or more gestures to a library of sign language signs.” While the capture and interpretation of visual elements is covered—both in the market, and in prior art and public disclosure of several technologies—both for the purposes of motion analysis and interpretation to the more “micro” of gestural interpretation, as cited here, again, this art very specifically cites capturing gestures from “outside” a sign-communicator, versus from the signer, which once again makes it impossible—physically—to have a (2-way) conversation between the signer and receiver, nor takes into account the “receivers” language for response, and the necessity to capture and translate it for a response, necessary to qualify as a “conversation”, which is interactive and modified in real-time based on information submitted from each participant.

Another example specific to sign-language “use” or capture and translation is U.S. Pat. No. 8,566,077, to Ander, et al. (2013). Its first claim cites “A digital sign language translator, comprising: a case configured to be supported by a hand of a user”. Once again, this art supports the “capture” of gestural communication/expression of one individual to another, which theoretically enables a non-signer to “understand” individual transmissions from a signer, but still does not provide a means to respond to said signer. If one redefines the “user” in this patent's claims to be the signer, of course, by being hand-held, its user can only record half of what it is “saying” through sign language, a language that is “spoken” through gestures of 2 hands. U.S. Pat. No. 8,493,174 to Agrawal (2013), furthermore adds the use of RFID trackers to record a signer's gestures, while this in theory is to add definition to individual point data versus having to parse point data from motion gesture information (via a computer), this is made moot by later prior art that does not require this added retrieval step, but furthermore separates the signer (sign language user) from any sort of real-time conversational context. It also further stigmatizes a sign-language user as “other” (American Sign Language, for example, is categorized in the U.S. as a “foreign” language, with the deaf community being categorized as a foreign residential community in America, versus an American community that necessarily uses a different mode of communication) This method reduces the individual to a scientific study model, a laboratory animal from which information can be extracted, an object, not a subject of a conversation.

Counterpointed with a wearable camera, as per U.S. Pat. No. 9,584,705 to Nordstrom (2017), for computer programs encoded on a computer storage medium, for wearable camera systems, in which is claimed “ . . . A system comprising; a camera system comprising; a camera; a wireless communications module; a memory storing a plurality of instructions; and a processor configured to execute the instructions stored in the memory and transmit images from the camera using the wireless communications module; a hat comprising: a brim; an orientation-specific receptacle embedded in the brim configured to receive the camera system in the brim and to detachably secure the camera system to the brim of the hat . . . ”, this embodies the core premise of a hands-free (wearable) camera, with the computation being image processing (analogue to digital conversion, compression, encoding). While this device captures visual data, it is specific to the function of traditional digital camera capture, excepting it is wearable. (Interesting as the company GoPro®, founded and active for over a decade from when this patent was issued, has generated close to a billion dollars in revenue from digital cameras intended specifically to be worn, or ultraportable, focusing on the sports market. The only recognizable different in U.S. Pat. No. 9,584,705 is the capacity to then send the digital information captured from the camera wirelessly to another device. This is interesting as wireless cameras have existed almost as long as GoPro®). While this art is specific to a wearable camera with a processor, it is clearly not for the function of a translation and verbal representation device for its bearer (wearer), and is simply a portable wireless camera.

Technically, a smartphone is a portable wireless camera, having the capture, processing, compression, encoding, and wireless sending capacities U.S. Pat. No. 9,584,705 discloses, though typically designed to be held or pocketed and not worn, many users do wear smartphones today (via after-market arm bands, such as for running, and some on head mounted after-market adapters). Yet smartphones are limited in their processing capacity, certainly for data-rich video, which can be compressed and stored (at least shorter lengths if high-definition video, which is necessary for gestural recognition). However, to process this amount of data for interpretation and transmission to a present second individual in their target mode of language reception would require—based on pre-existing technology of today—ex-smartphone cloud processing which, based on lag time for transmission to and from said processing location, would allow neither for conversational speed two-way dual-mode converted conversation, nor begin to account for the processing necessary to convert and translate verbal (audio) data from the second party responder and transmitter in the conversation to the sign-language speaker.

To summarize, while there are nascent programs that can map and translate sign language into other language modes (e.g. text) and languages (English, Spanish, et al), they are both limited, and for the purposes and comparison with our invention, unidirectional. Meaning, they translate in one direction, and thus are not enabling of actual conversational flow between signing and non-signing people in real time. In the cases where the operator of (fairly large) computer system and video recording system is unobstructed from the “signer”, and the signer has fluency in lip reading—in that verbal-only speaking individual's target language—short communication bursts of basic meaning can be conducted. These, however, are not—and cannot be—based on the structural limitations of that technology, be free-flowing normal conversations.

### Advantages

Introduction. Accordingly, several advantages and objects of the present invention are:

A principal advantage of the present invention is to provide a means to capture, record, interpret a user's signed language from their point of view, so that they can communicate with both their hands without holding a device, and said device can then translate this signed (visual) language into a second mode of language used by a second party in a conversation with the primary user, such as verbal language, speaking it in the target language of that secondary user, such as English (or Mandarin, or German, or any other major verbal language).

Another advantage of the invention, is to perform this translation at the speed of spoken language in a conversation so that a sign-language user can communicate via the device at typical speed of a verbal language speaker (such as the devices secondary user) in order to facilitate a (“back and forth”) conversation, versus a staggered exchange of information, such as is the current case when using a human interpreter working between two individuals using different modes of language (e.g. visual versus verbal).

Another advantage of the invention is to translate from the language mode of a secondary user of said device, for example, an English speaker using verbal language mode, into an immediately understandable mode for the primary user of the device, such as spoken English converted into text which the primary user can read as text on the device's display.

Another advantage of the device, as there are even more spoken languages in use than sign languages, is to convert a “foreign” spoken language of a secondary user into both an understandable mode for the primary user (such as text), but also into the primary user's core associated language (such as English), For example, the primary user may speak French Sign Language, and also understand English textural language, whereas a person they want to converse with only speaks (verbally) Italian. Our device could receive the Italian verbal/sound (even auto-detect and automatically switch DB/mode for versus its primary user having to manually select ahead of time for spoken Italian, depending on the embodiment), and then convert into English text—or French sign symbol for display, depending on the embodiment.

### SUMMARY

Millions of people suffer from impaired speaking and hearing abilities; a significant communicate by sign (visual/gestural) language, such as American Sign Language (ASL), where letters may be formed by various hand gestures. This means of communication has proven sufficient for conversational-level richness of data transfer between individuals both using sign language to communicate with one another, however, recent advances in technology have allowed for basic gestural capture and interpretation for one-way conversion into text, only allowing for a person using sign language to communicate basic concepts to a non-speaker via a computer interface. In view of the limitations now present in the prior art, the present invention provides a new and useful means of converting a wearer's visual language input into verbal language output to a second individual's auditory reception, while also—at conversational speed, converting this second individual's response into a visual format for the wearer of our device, in the process enabling “normal” conversational flow communication between two individuals previous unable to communicate beyond very basic concepts.

A principal object of the invention is to provide a means to capture, record, interpret a user's signed language from their point of view, so that they can communicate with both their hands directly facing another individual (non-sign speaker-listener) without holding a device, and said device can then translate this signed (visual) language into a second mode of language used by a second party in a conversation with the primary user, such as verbal language, the device speaking it (via sound) in the target language of that secondary user, such as English.

Another object of the invention is to perform this translation at the speed of spoken language in a conversation so that a sign-language user can communicate via the device at typical speed of a verbal language speaker to hold a true conversation with another non-signing human (communicator).

Another object of the invention is to translate from the language mode of a secondary (non-sign speaking individual) into a mode understood directly by the initiating user of the device, such as text, so that they can be understood directly by the primary user of the device.

### Summary of the Embodiments

The purpose of the present invention is to provide a means to communicate between two people in real-time but between two different modes of language at the same time, at the most complex ends of the spectrum, between one person whose primary mode and language of communication is through visual symbolic language (e.g. Sign Language and American Sign Language) and another person whose primary communication mode and language is verbal (spoken) English (or Mandarin, et al).

As the background section helps to illustrate, a broad difference between our invention in wearable computing, gesture capture, or language translation prior art is that our invention interacts with its primary (sign-language communicating) user as a subject in a conversation with another individual using a different mode of communication and language versus an object to be understood and translated. In all embodiments, our device is worn since it can only perform its core function must hands-free; its primary user needs both hands to communicate using sign-language. In addition, to enable “face to face” communication between a signing and non-signing individual, it must also have the same viewing perspective as its primary user, the wearer (“bearer”), so that that individual can directly face the other person they wish to converse with. Our device also (verbally speaks) on the primary user's behalf to the non-signer in the conversation, but we refer to the non-signer in the conversation as a “secondary user” as our device also captures and translates that individual's vocalized communication and presents it to the primary user in a preferred mode and type format readily understood by its primary user (text or symbol, depending on the embodiment).

The primary embodiment of the present invention provides systems and methods for capturing (via lens on the front of a device, and image sensor within that device) and then translating the sign language of a user of our device, which is worn to capture the wearer's hands, their articulation, and movement from their point of view, then matching that to a preferred sign language database before interpreting, and translating into another language (e.g. English, Mandarin, Spanish), and mode of communication (e.g. verbal), and then communicating on behalf of that wearer in the mode best understood by the second person involved in the conversation, for example, verbally, through a (physical) speaker on the device.

Additionally, the device receives communication input from the second participant in a conversation, in the preferred embodiment, via vocalized language, through a microphone (which is also part of the device), It then digitizes, interprets meaning, translates that input into the language selected by the primary user, before converting it to a format (mode) conducive to understanding for the primary user, In the preferred embodiment, this is text, which is displayed on an LCD display panel on top of the worn device. This is displayed as ticker tape, and in an alternative embodiment, the LCD display allows for touch-screen control, so the sentence can be paused, reversed, forwarded, or by double click, individual words can be further defined. In the primary embodiment, the device is worn by use of a necklace or cord, around the user's neck, so that the front of it rests on the user's chest, comfortable behind the natural position of the user's hands when communicating by sign language.

In the primary embodiment, the databases for two languages (visual: ASL & verbal: English, as example) reside on the device, and the processing for interpretation and translation are also performed within the device. However, it is possible that the device could use wireless transmission to send and receive data to off-board processing, such as for cloud processing. This is especially likely should users of said device want to use additional languages at a moment's notice that are not stored in the device's database, such as when traveling, or if wanting to communicate with a foreign language speaker in their normal geographical location.

A secondary embodiment does not rely on a standard power button for power on/off functions, but rather uses an embedded motion sensor to determine presence of a second person at a range and field of view that would signal their intent to initiate a conversation. This embodiment also first identifies the language of the (non-wearer) being spoken, and adjusts based on that input (e.g. if in German, accesses a German database for mapping and translation); this database can either be on-board or off-board (such as in a cloud, accessed by wireless transmission).

Another embodiment allows two of the same device to be used by 2 individuals speaking different (verbal languages), but facilitates a fluid conversation between those two individuals by interpreting and translating each participants statements or response into the language of the other individual, and speaks on their behalf when they have paused for a significant period of time (3 seconds or more). This essentially allows for fluent, real time conversation between two individuals, each in their preferred language for speaking and receiving information.

### BRIEF DESCRIPTION OF THE DRAWINGS

The following drawings further describe by illustration the advantages and objects of the present invention in various embodiments. Each drawing is referenced by corresponding figure reference characters within the “DETAILED DESCRIPTION” section to follow.

FIG. 1 is a front view of this invention, in an exemplary implementation of this invention.

FIG. 2 is a side (A) and side (B) view of this invention.

FIG. 3 is a top down view of the invention, showing a display panel.

FIG. 4 depicts a primary user of our device from the side, gesturing in front of the device using sign-language, and a second non-signing individual who desires to converse with the primary user.

FIG. 5 shows the device from above worn on the user's (wearer's) upper torso, receiving sound waves from a second individual's spoken language.

FIG. 6 shows an individual speaking to our device's user.

FIG. 7 shows the top-down view of the invention, with a text display, displaying in ticker-tape style the text—or symbolic—translation of the secondary user's verbal statement for understanding of the wearer of our device.

FIG. 8 is a flowchart describing core software functions of the primary embodiment of our device; and the device's primary unique algorithm(s) for the unique function for the software component of the overall device.

FIG. 8A is a continuation of the functional flowchart, with added detail.

FIG. 8B is a further continuation of the functional flowchart 8.

FIG. 9 shows a secondary embodiment, where the verbal input received by the device is relayed off-device via wireless transmission to the cloud for processing, then returning to the device, converted into data to be displayed as text on the device.

FIG. 10 shows another embodiment in which our device, though use of motion sensing, activates when an individual approaches its wearer. The device then detects the primary semiotic medium (spoken vs. visual language) used by the other individual to converse, then the sub-set, or specific language, e.g. spoken Italian, American SignLanguage to translate for the wearer automatically.

FIG. 11 shows the verbal language from a second person, as seen in FIG. 10, being received by the device and then being translated in the user's pre-selected preferred written language, in this case English.

FIG. 12 shows an alternative embodiment where our device is worn by two people, in this case, the primary function modified for dual-real time verbal language translation, for both translating the other's language into a language the wearer A understands, and then translating their response from their language into the other's wearer B's language through a speaker on the device, and then vice versa for the other wearer (A).

### DETAILED DESCRIPTION

introduction. The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims. Various embodiments of the present invention provide systems and methods for a wearable translation and communication device. The operating system of the worn device may be enabled to accept visual and gestural information from its primary user (wearer) that is converted by the device into another language mode (e.g. verbal), and language (e.g. French) to then be spoken (verbally) by the device to another individual the wearer has chosen to engage in a conversation. Likewise, the other person can respond in their language mode (e.g. verbal), and language (e.g. French or Kiswahili), which is received by the device which is worn in front of its primary user, via microphone, before it is interpreted, converted to the desired mode and language of the primary user then communicated by the device to that primary (or “initiating”) user. For example, to the sign-language user in this example, to English text, displayed on the device.

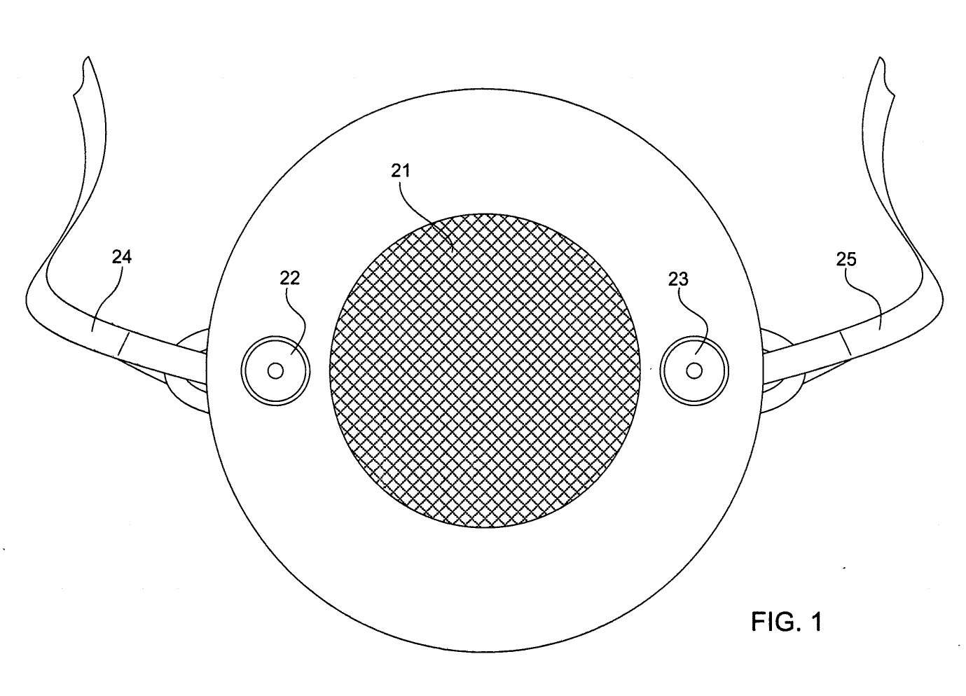

Preferred embodiment: the device (front view) shown in FIG. 1 is approximately the size of an ornamental necklace, though larger than a standard locket (due to the necessary hardware to perform all of the disclosed functions), but is still light and compact enough to be comfortably worn, and also to be visually unobtrusive, so that its wearer can be the focus on communicating hands-free, and not the device itself. This front view, FIG. 1, also details the main observable external components of the device, in this embodiment, namely, a lens 21, through which an image sensor records gestural/visual communication from the wearer's hands to be converted from analogue to digital data before being analyzed. It should be noted, part of the machine intelligence of our device is in interpreting core visual (sign) language components, which will be captured from behind a sign-communicator's hands. Then it can be mapped to a database of signing symbols for that specific sign language. In addition, as a wearer has the use of both hands, they can communicate hands-free, and the device is designed to be worn on the user's front in their preferred location, e.g. chest, front of shoulder, any location so that their natural hand positions when signing can be used with the device so that is it a natural extension of their communication process.

FIG. 1 also shows a microphone 22 for use in capturing the (non-signing) voice communication of the other individual engaged in conversation with the device's wearer.

FIG. 1 also shows a speaker 23 through which the device sends the wearer's communication, translated from sign into voice for the receipt of the other individual engaged in the conversation.

FIG. 1 also shows sections of straps 24, 25 through metal loops on the device, as straps can be used with the device for ease of wear for the user, in this case as a necklace should the wearer prefer to wear it at chest level (behind their hands for signing). Other means of connection could be used to place the device in other locations on the wearer's body, based on their preferred location for personal comfort and ease of use.

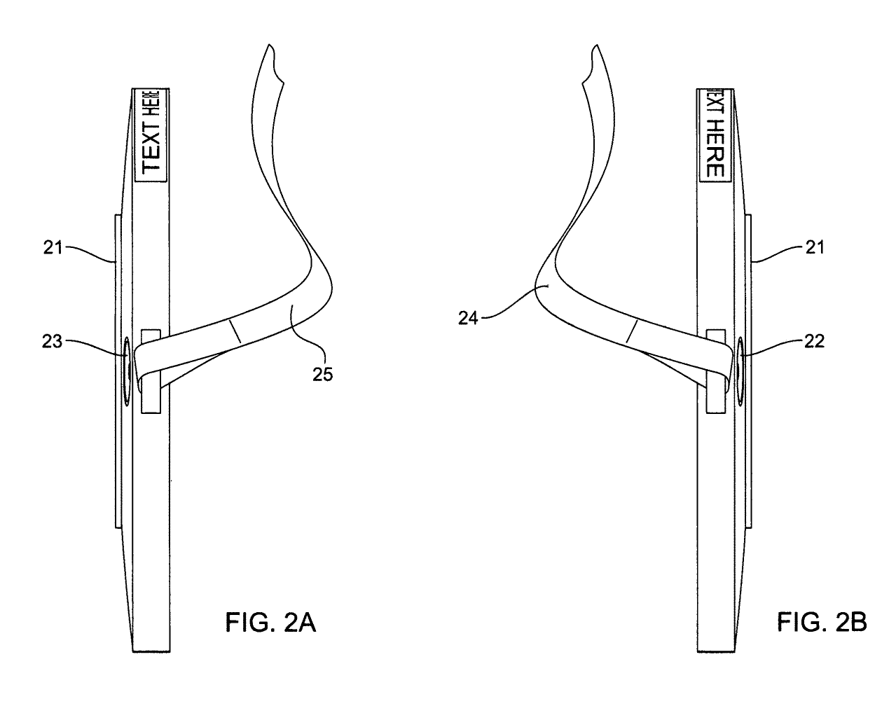

FIG. 2 shows both side views of the device, FIG. 2A and FIG. 2B.

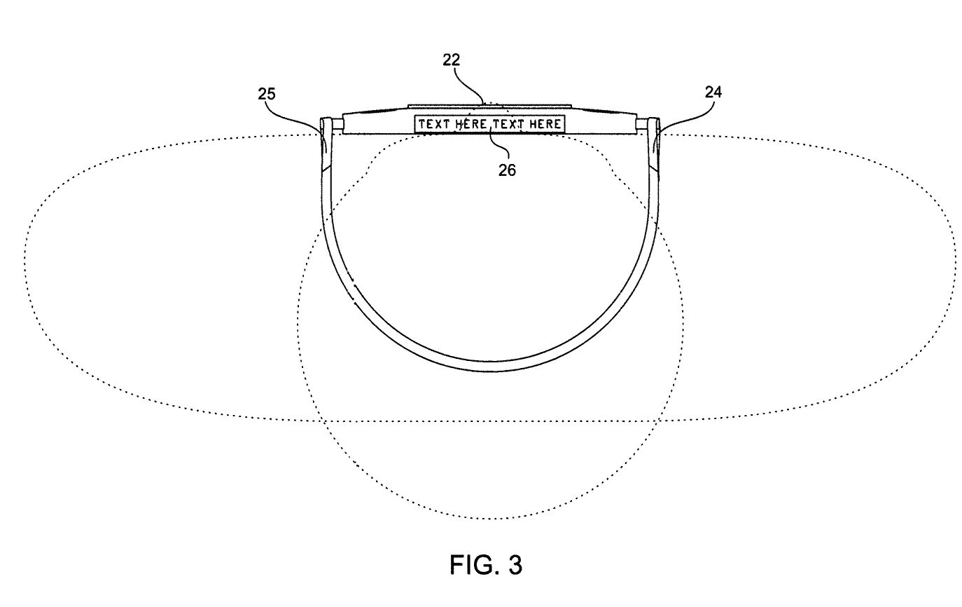

FIG. 3 shows a top down view of the device as worn on the user's upper torso. In the preferred embodiment, the device has a display screen 26, from which is displayed text from the translated verbal input from the other person the wearer is conversing with. Once the device has translated verbal digital data into text in the language selected by the wearer/user, in this case English, it is displayed on the device's screen. While many signers who use American Sign Language also can read English, many live in non-English speaking countries, where the main verbal language could be Greek, while the dominate signing language there, in that deaf community, is American Sign Language. In the preferred embodiment, the text on display 26 auto-scrolls across the screen, similar to a ticker tape display. In the preferred embodiment, the display is touch activated, so that the text can be paused, reviewed or individual words double-tapped to prompt the device to further define the meaning of an individual word.

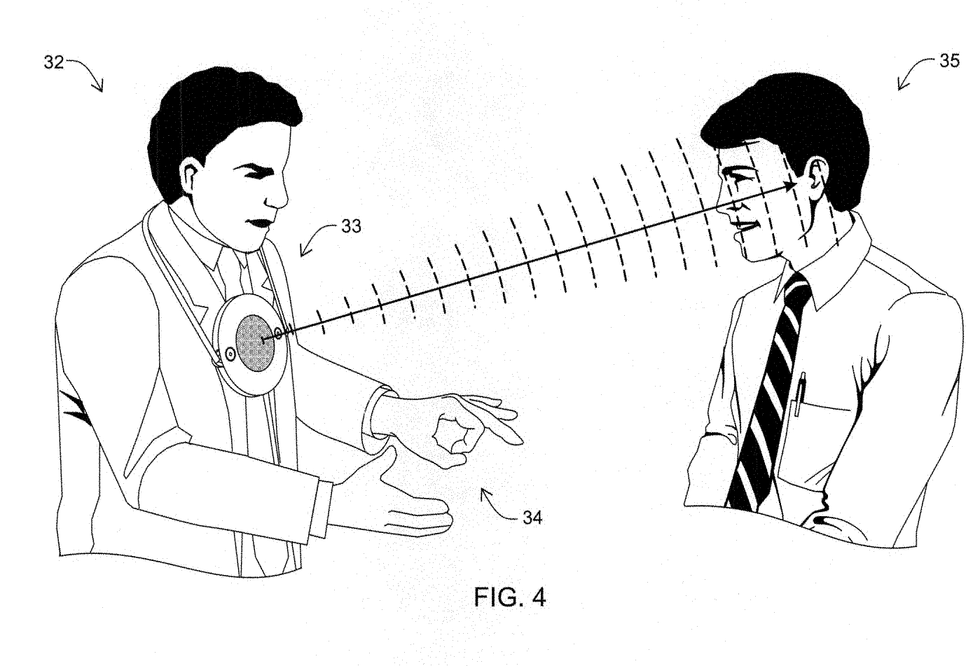

FIG. 4 depicts a primary user 32 of our device from the side, gesturing with hands 34 in front of the device so that it can capture this gestural communication as input for translation to verbal language using sign-language, and a second individual 35 also from the side partaking in a conversation. This illustration depicts the sound of vocalized output from device 33 of the translated sign language (gestural) input from primary user 32 as a sound wave traveling to the second individual 35.

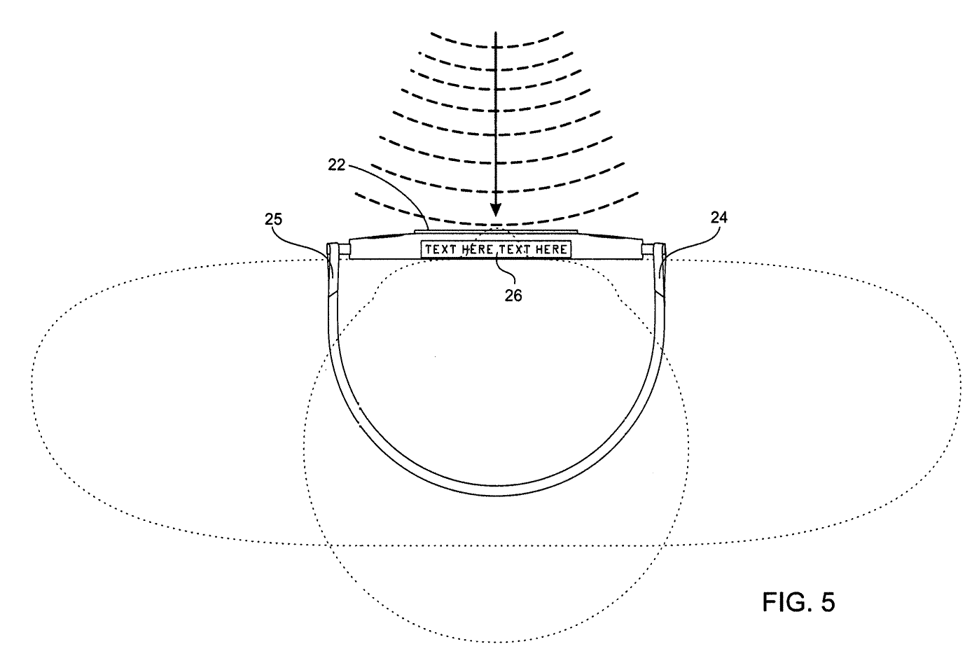

FIG. 5 shows the device from the primary user's 32 point of view receiving a verbal response to the machine's verbal response shown in FIG. 4, which will be momentarily translated for the wearer, and displayed in the preferred language selected by user in text on the device display 26.

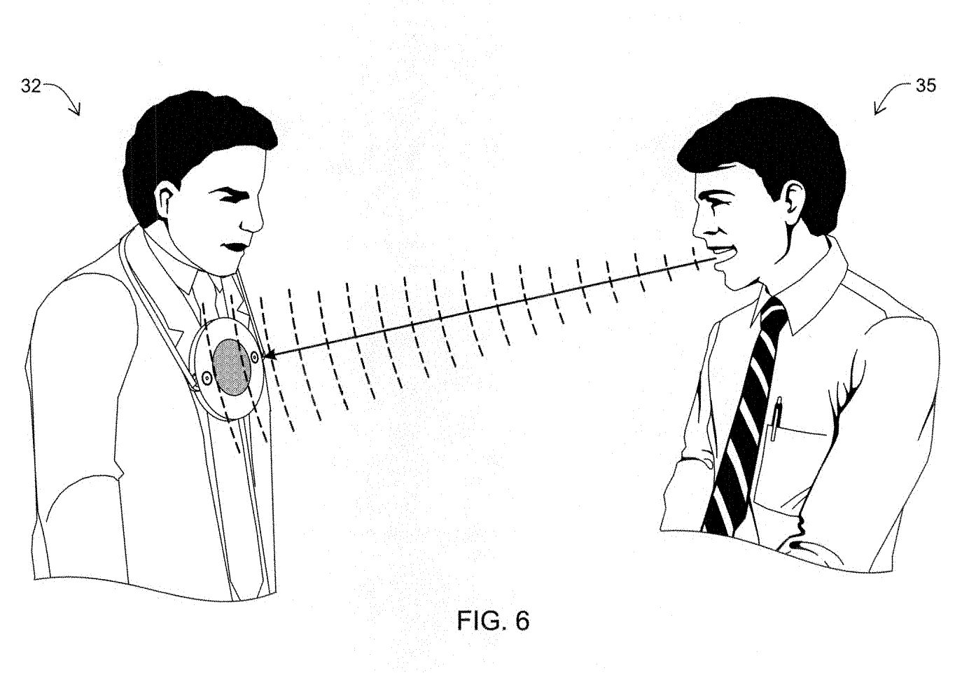

FIG. 6 shows the secondary user 35 verbally responding to the information communicated to him, and the sound waves of his communication traveling from his mouth to the microphone on device, where it is then converted to digital data before being translated into text in the primary user's 32 choice to be read from the device display.

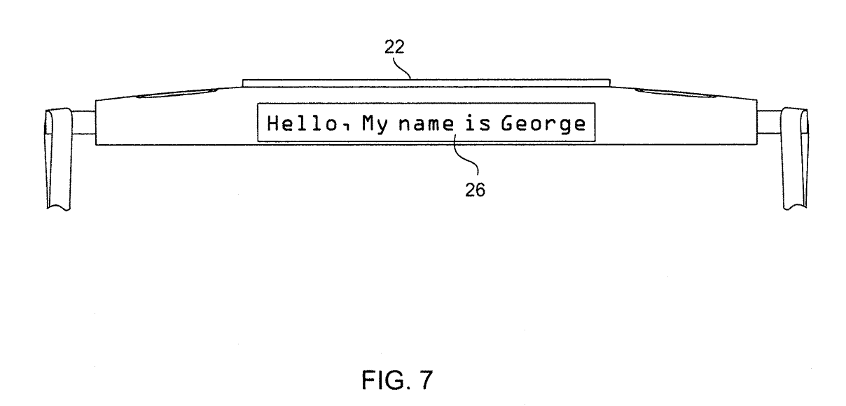

FIG. 7 shows the top-down view of the device, with the display showing the verbal communication shown in FIG. 6 as either text or symbolic language on the display 26.

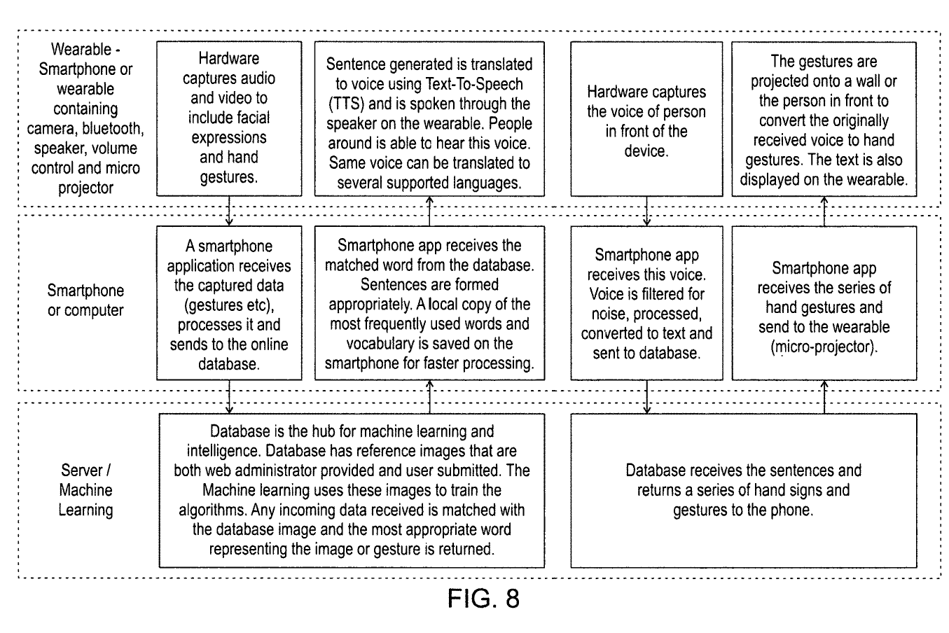

FIGS. 8, 8A, and 8B depict the core software functions of the primary embodiment of our device; and the device's primary unique algorithm (s) for the unique function for the software component of the overall device.

Operation—FIGS. 4, 5, 6, 7: In the primary embodiment the device is worn at chest level, behind a user's presenting (signing) hands, and below their line of sight, so they can easily use both of their hands to communicate fluently and eyes to see the device display without having to hold a device with one of their hands, thus limiting their communication capacity as a sign-language user. In the primary embodiment, the device's system is already pre-loaded with a database of at least one sign language and one spoken language, for example American Sign Language and English. The primary user (wearer), powers on the device when they wish to start a conversation, and the device can either “start” in translation-conversational mode when a second individual speaks (activating its voice recognition and filtering mode and translating to text in the primary user's chosen text language). Or, the primary user (wearer) brings their hands to a normal signing position (in front of the device), which activates the visual language capture, conversion, translation, and output of translation via speaker on the device to the second person.

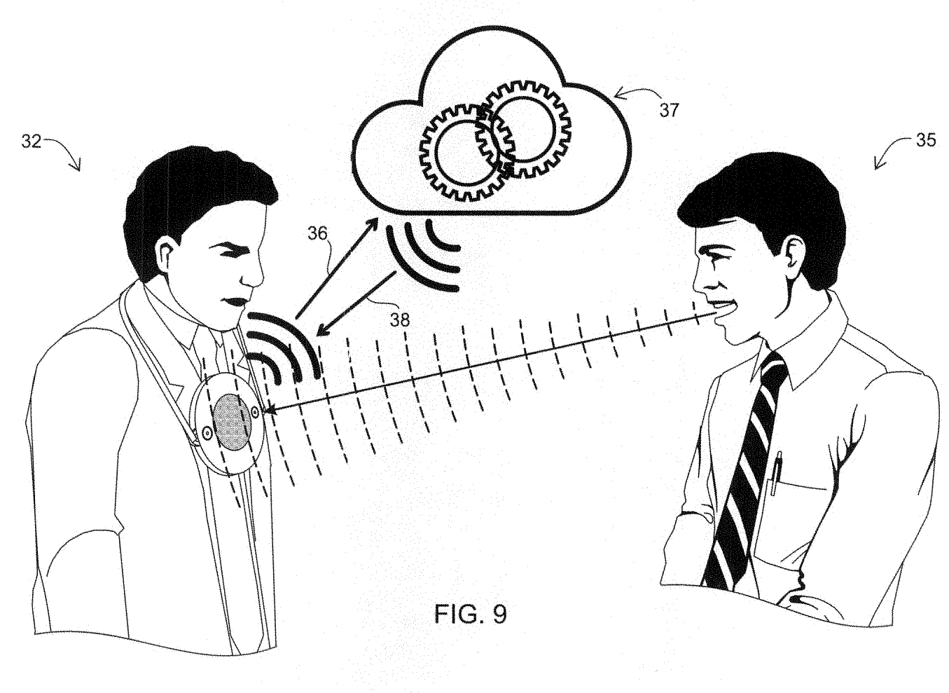

Additional embodiment. FIG. 9 shows a secondary embodiment, where spoken language is recorded and relayed off-device via wireless signal 36 for cloud processing 37 (analogue to digital, interpretation and translation, in this case into written English), then returning 38 to the device converted into data to be displayed as text. This would allow for an even higher number of language databases to be accessed versus the onboard storage of pre-chosen languages as described in the primary embodiment, due to storage space limitations on a portable and wearable device.

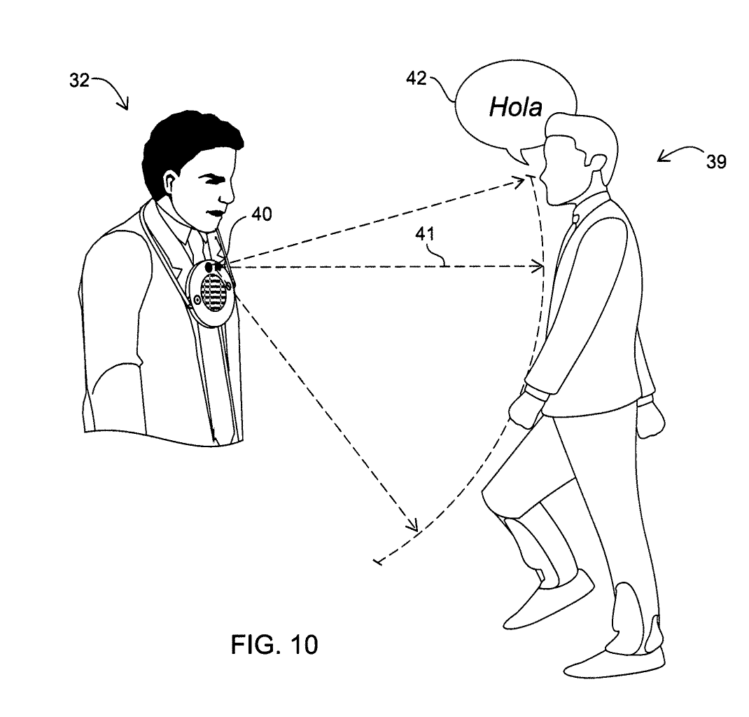

FIG. 10 shows a stranger 39 approaching the primary user 32. When the stranger, 39, is approximately five feet away 41 from the user 32, the device's motion sensor 40 powers on the device to “active” mode. As personal and conversation zone boundaries vary from culture, five feet is shown here as an average distance and may be adjusted and set by individual user based on their preference for this secondary embodiment's motion sensing function. Additionally, stranger 39, greets user 32, in this case the stranger 38 is a native Spanish speaker, so he says: “Hola” 42.

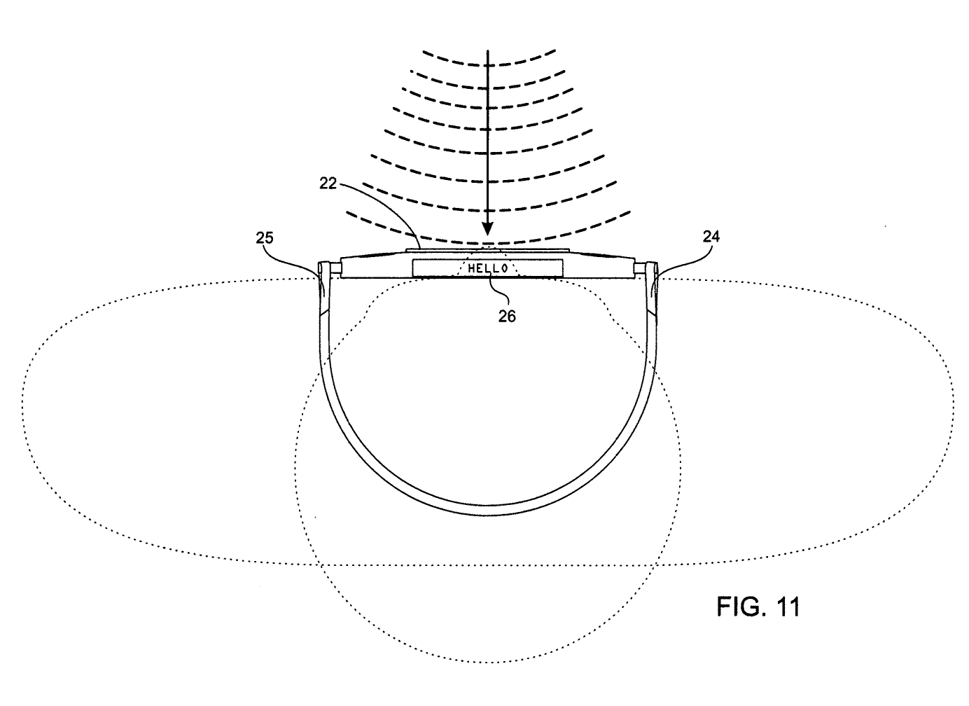

FIG. 11 shows the user 32 device which is received by the device, converted and translated into “HELLO” as text. “HELLO” is the English translation of the Spanish word “HOLA” in. This translation is displayed on the device's display panel 26.

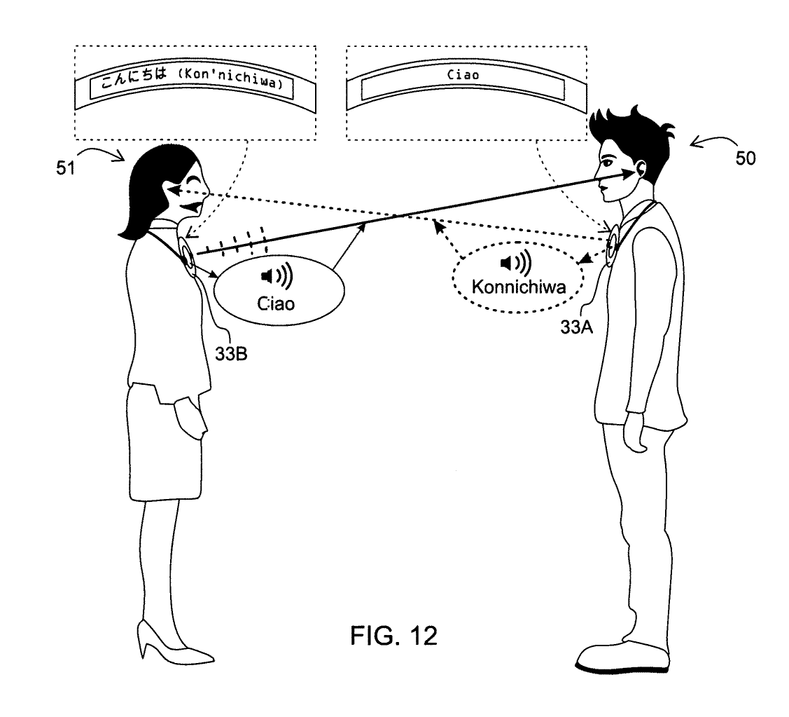

Alternative embodiment. FIG. 12 shows two individuals, User A 50, a native Italian speaker, User B, 51, a native Japanese speaker each wearing our device 33A and 33B, respectively. Both devices are set to receive verbal language in each of two different languages (33A, Italian voice input, translated and outputted verbally to Japanese via device speaker, and 33B in Japanese voice input to device, output verbally in Italian via speaker) and respond in second language for two people facing each other without having to use human translators, or reference guides to interpret each line in a single language. In addition, each device is set to either verbal or text (mode) translation into preferred user language; User A (50) hears the translated Japanese in Italian, and User B, (51) hears the translated Italian in Japanese. Alternatively, both can set their devices to read the translation via text. This illustration also shows an alternative placement of our device, 33A, on the front of their left front of shoulder, based on user, 50, preference.

I claim:

1. A device worn by one individual, but used by two individuals to facilitate conversational communication from individuals using different language media; one individual using gestural (visual) language and the other individual spoken (verbal) language. Its wearer (Individual A) uses a symbolic-gestural based language as their primary means of communication, and Individual B uses a spoken language as their primary or preferred mode of communication. The method comprising: a device receiving vocalized language from Individual B through its microphone, converting this analogue data to digital data, determining the language being used to map to a language database, and converting and displaying it in symbolic form (text or image) for the wearer (Individual A) to receive and understand what is being communicated. The wearer (Individual A) communicates using gesture, the worn device is worn on Individual A's upper torso, behind their two hands, and so captures their gestural (visual) communication via image sensor (through a lens embedded in the device), converting it then into digital data, mapping to a database of the target spoken language of Individual B, then outputting this communication through an amplified speaker on the device to “speak” on behalf of Individual A to Individual B. This back-and-forth live conversion is completed rapidly so that it can facilitate a normally paced fluent conversation between these two individuals.

2. The device of claim 1, wherein the device has access to at least two language databases, one gestural, such as American Sign Language, the other spoken and written, such as English.

3. The device of claim 1, wherein the device has off-device access to multiple spoken languages and a chosen primary gestural language for wearer, so that, by use of the device's language recognition software, the wearer can converse with various individuals they come in contact with in their native spoken language.

4. The device of claim 1, in which the text or symbol display on the device is touch-activated, so that sentences or symbol strings can be paused by the user.

5. Furthermore, the touch-screen display of claim 4, by which a user can double-tap on an individual word or symbol to request further definition via the device's database.

6. The touch-screen display of claim 5, in which after an individual selects a word or symbol for further definition and receives it, can tap the touch-screen device to restart the text to continue moving.

7. A worn device for facilitating conversational-speed multimedial translation that detects an Individual approaching through the motion sensor at a distance of approximately 5 feet (the exact distance for this “personal communication boundary can be set by the wearer of device). This device then uses language recognition software to determine the specific language being spoken by the individual approaching the device's wearer, to ready the device for translation from that language into the preferred mode of language selected by its earer

8. A worn device for facilitating conversational-speed multimedial translation, that is between one semantic system and another (gestural and spoken), that capture's its wearer's gestural communication from their point-of-view as it is a worn device, and the other participant in the conversation via vocalized language and its microphone before transliterating, or by lip movement through the devices lens, image processor, and separate mouth-gesture database relating to that specific spoken language.
